(19) United States
(12) Patent Application Publication
(10) Pub. No.: US 2021/0078909 A1
(43) Pub. Date: Mar. 18, 2021

(54) WEAR-RESISTANT COATING

(71) Applicant: THE UNIVERSITY OF NOTTINGHAM, Nottingham Nottinghamshire (GB)

(72) Inventors: Tanvir HUSSAIN, Nottingham Nottinghamshire (GB); James MURRAY, Nottingham Nottinghamshire (GB)

(21) Appl. No.: 16/620,178

(22) PCT Filed: Jun. 6, 2018
(86) PCT No.: PCT/GB2018/051547

§ 371 Date: Dec. 6, 2019

(30) Foreign Application Priority Data
Jun. 6, 2017 (GB) 1708997.0

(51) Int. Cl. C04B 35/622; C04B 35/117; C23C 4/11; C23C 4/129

(52) U.S. Cl. CPC C04B 35/62222; C04B 35/117; C23C 4/11; C04B 2235/3217; C04B 2235/5292; C04B 2235/5436; C23C 4/129

(57) ABSTRACT

A method of coating an object, the method comprising: preparing a suspension comprising graphene nanoplatelets and a ceramic material; and spraying the suspension onto the object using high velocity oxy-fuel, HVOF, spraying in which the suspension is introduced as a feedstock.

### FIELD OF THE INVENTION

The invention relates to a method of applying a wear-resistant coating to an object by high velocity oxy-fuel (HVOF) spraying.

### BACKGROUND

Thermal spraying techniques are commonly used to apply protective coatings to objects by heating or melting a feedstock (i.e. a coating precursor) and spraying the heated material onto the object.

High velocity oxy-fuel (HVOF) is one such technique. In HVOF, a mixture of gaseous or liquid fuel and oxygen is combusted to generate a combustion flame. The feedstock is fed into the flame at pressure, which heats the feedstock and accelerates it towards the surface to be coated. Flame temperatures can reach 2500-3100° C., allowing materials with high melting points, such as ceramics, to be successfully deposited. The flame can accelerate the feedstock to very high speeds, for example approaching 800 m/s. HVOF spraying achieves coatings that have low porosity and high bond strength. A low porosity is important for maintaining the structural integrity of the coating.

In traditional HVOF spraying, the feedstock is a dry powder. Recently, suspension high velocity oxy-fuel (SHVOF) has been proposed. In SHVOF, particles of the precursor material are dispersed in a suspension (i.e. in a fluid such as a liquid). The suspension is used as the feedstock, and is fed into the combustion flame in a similar way to how dry powder is fed into the flame in conventional HVOF. As particles of the coating precursor are dispersed before being sprayed, SHVOF can achieve a more uniform coating than conventional HVOF spraying, which is particularly important when a combination of materials is used as the coating precursor. Suspension sprayed coatings also tend to have a finer grain size and pore size, less anisotropy, and lower surface roughness than conventional, dry, HVOF sprayed coatings. Suspension sprayed coatings can be thinner than conventional thermal spray coatings, bridging the gap between thermal-sprayed coatings and vapour deposition coatings.

It has been found that adding nanomaterials to coatings can reinforce the coating, increasing wear-resistance. Nanomaterial-reinforced coatings can be applied using some thermal spraying techniques, but difficulties can arise due to the high heat the nanoparticles experience during the spraying process. Nanoparticles may be oxidised or even disintegrated in the high temperatures involved in thermal spraying.

Agarwal et al. investigated carbon nanotube (CNT) reinforced coatings applied using various thermal spraying techniques, particularly conventional (dry) HVOF spraying and plasma spraying [1]. Plasma spraying is an alternative to HVOF spraying, which uses a jet emanating from a plasma torch to melt and accelerate the feedstock towards the surface to be coated.

Agarwal et al. discloses it is possible to produce a CNT-reinforced coating using a physically blended (dry) combination of a conventional coating precursor (Al—Si powder) and carbon nanotubes as the feedstock for HVOF and conventional plasma spraying. This document discloses that when a suspension of carbon nanotubes is used as a precursor for plasma spraying, the CNTs do not survive the spraying process due to the high temperature of the plasma flame, and no way of producing a CNT-reinforced coating from a suspension based precursor is disclosed.

Agarwal et al. concludes that, for a CNT reinforcement to survive a high temperature process, it is essential for the CNT to be in direct contact with particles of the feedstock powder in the precursor, so that a protective layer of alumina is formed around the CNTs during spraying, preventing the CNTs from disintegrating. Agarwal et al. teaches that such a protective coating does not form when a suspension of CNTs is used. The direct contact between the conventional precursor powder and the carbon nanotubes in the dry feedstock powder allows the protective coating to form during the conventional techniques. Using a solution prevents this direct contact, preventing formation of a protective layer and leading to vaporisation of the CNTs in the high temperature flame.

Agarwal et al. thus discloses that conventional, dry HVOF and plasma spraying can be used to apply a CNT-reinforced coating, but that a suspension-based precursor is not appropriate. However, using dry powders can lead to non-uniformities in the coating layer and agglomeration of nanoparticles, limiting the effectiveness of the coating.

### SUMMARY OF THE INVENTION

In accordance with a first aspect of the invention there is provided a method of coating an object, the method comprising: preparing a suspension comprising graphene nanoplatelets and a ceramic material; and spraying the suspension onto the object using high velocity oxy-fuel (HVOF) spraying in which the suspension is introduced as a feedstock (i.e. SHVOF spraying). The suspension may be a liquid suspension.

Graphene nanoplatelets (GNPs) are a form of graphene in which platelets comprise a stack of a small number of graphene sheets, for example 5-30 layers, which may retain many of the properties of single layer graphene. GNPs have similar behaviour and properties as pure graphene in many respects, and have cheaper production costs in comparison to single layer graphene.

Surprisingly, it was found that graphene nanoplatelets were able to survive the high temperatures of the HVOF flame, even though the nanoplatelets were dispersed in a suspension before being injected into the flame. The prior art suggests that using a suspension comprising carbon-based nanoparticles as a feedstock for HVOF spraying would lead to disintegration of the nanoparticles, especially as materials in an HVOF flame react more aggressively with oxygen in the flame than the aerosolised CNTs in Agarwal et al. Surprisingly, this was found not to be the case for the graphene nanoplatelets.

It was found that the graphene nanoplatelets reinforced coatings in accordance with an embodiment, increasing the wear-resistance of the coating. In particular, dry-sliding wear tests at a 10 N load yielded a two order of magnitude reduction in the specific wear rate for an alumina/GNP composite coating applied by SHVOF spraying in comparison to a pure alumina coating.

In some embodiments the suspension may comprise graphene nanoplatelets having a thickness in the range 4 nm to 25 nm, or between 5 and 30 layers of graphene. For example, at least 50 wt % or at least 70 wt % or at least 90 wt % of the graphene nanoplatelets in the suspension may have a thickness in the range 4 nm to 25 nm. In some embodiments the suspension may comprise graphene nanoplatelets having an average thickness in the range 5 nm to 10 nm, or in the range 6 nm to 8 nm. The average thickness may be for example be determined by Raman spectroscopy of the nanoplatelets: before dispersion in the suspension, in suspension, or after application of the coating, or for example by atomic force microscopy (AFM), scanning electron microscopy (SEM), or transmission electron microscopy (TEM). The average thickness may be the mean thickness of a plurality of nanoplatelets determined by such methods, for example the mean thickness of 20 or 50 or 100 nanoplatelets (which may be selected at random).

Such thicknesses increase the survivability of the nanoplatelets in the high temperatures of the HVOF flame. If thinner nanoplatelets are used, there is an increased likelihood that the nanoplatelets will disintegrate in the flame. If thicker nanoplatelets are used, the nanoplatelets may not disperse in the suspension as effectively, potentially leading to a less uniform distribution of nanoplatelets in the finished coating, or even to the nanoplatelets falling out of the suspension.

In some embodiments the suspension may comprise graphene nanoplatelets having an average diameter in the range 1 μm to 7 μm, or in the range 4 μm to 6 μm. The diameter of the nanoplatelets may be determined for example by scanning electron microscopy (SEM). The average diameter may be the mean thickness of a plurality of nanoplatelets determined by such methods, for example the mean diameter of 20 or 50 or 100 nanoplatelets (which may be selected at random). Alternatively, the volume equivalent median (Dv50) diameter may be determined with reference to a laser diffraction measurement. Such diameters of nanoplatelets may further increase survivability of the nanoplatelets in the HVOF flame.

The large diameter of the graphene nanoplatelets, particularly in comparison to carbon nanotubes, also limits the amount of material that is broken off during wear. Carbon nanotubes, being very small, easily rub off a coated surface into the atmosphere, where they can damage other components of a system. Many engineering applications have tight specifications on release of nanoparticles in the atmosphere due to nanotoxicity. The larger diameter graphene nanoplatelets are less likely to rub off and cause damage to other components.

In some embodiments the ceramic material may be or comprise alumina. For example at least 50 wt %, or at least 70 wt %, or at least 90 wt % of the ceramic material may by alumina. In some embodiments the ceramic material may be or may comprise gamma-phase alumina. For example at least 50 wt %, or at least 70 wt %, or at least 90 wt % of the ceramic material may by alumina in the gamma-phase.

In some embodiments, after SHVOF spraying the ceramic material may comprise at least 50 wt % or at least 70 wt % or at least 90 wt % gamma-phase alumina.

For conventional pure alumina coatings, the alumina feedstock normally comprises the desirable alpha phase of alumina, which gives a better wear performance than other phases of alumina. However, in the high temperatures of the HVOF flame, it is difficult to retain the alpha phase, and often the gamma phase forms. The gamma phase has poorer wear properties owing to its lower fracture toughness and hardness. Avoiding the gamma phase requires careful selection of typically lower flame energy parameters, which in turn can exacerbate the prevalence of porosity and hinder coating properties.

It was found that the reinforcement provided by graphene nanoplatelets significantly increased the wear resistance of gamma phase alumina coatings. This limited the detrimental impact of the alumina phase change in the HVOF flame, so that the phase change did not need to be avoided. As a result, a highly wear-resistance coating with low porosity was achieved.

Other ceramic materials may be used, instead of or in combination with alumina. For example, compositions of graphene nanoplatelets with TiO₂ (anatase), TiO₂ (rutile), TiO₂ (titania), Cr₂O₃, ZrO₂ and TiN were found to provide a wear resistant layer when sprayed onto a surface using SHVOF spraying.

In some embodiments, the wt % of graphene nanoplatelets in the suspension may be in the range 1% to 30% of the wt % of the ceramic material in the suspension.

In some embodiments, the ratio of HVOF flame power to injection flow rate of the suspension may be between 0.5 and 1.5 kW(ml/min)⁻¹, or between 0.8 and 1.2 kW(ml/min)⁻¹. The flame may have a flame power of at least 80 kW or at least 100 kW, or between 80 kW and 120 kW.

In some embodiments the combustion stoichiometry of the oxygen and fuel for producing the HVOF flame may be between 90% and 100%. The fuel may be hydrogen.

Surprisingly, it was found that an increased flame power increased the survivability of the graphene nanoplatelets. The increased flame power accelerated the graphene nanoplatelets to higher speeds, reducing the amount of time the nanoplatelets spent in the flame. Less time in the flame increased the likelihood of the nanoplatelets surviving the spraying process without oxidation or disintegration.

In some embodiments, preparing the suspension may comprise: preparing a first suspension comprising the ceramic material; preparing a second suspension comprising the graphene nanoplatelets; and combining the first and second suspensions. In particular, combining the first and second suspensions may comprise adding the second suspension to the first suspension. Preparing the suspension, or preparing the first and/or second suspension may comprise stirring the suspension and/or applying ultrasonic vibrations to the suspension.

In some embodiments the suspension may be an aqueous suspension. For example the ceramic material and graphene nanoplatelets may be dispersed in deionised water.

In some embodiments the ceramic material may comprise particles having a Dv50 particle size in the range 1 μm to 20 μm, or in the range 1 μm to 10 μm.

In some embodiments a stabilising additive may be added to the solution prior to HVOF spraying. If the solution of graphene nanoparticles and ceramic material is not stable (or if one of the first and second suspensions is not stable), the stabilising additive may be added to stabilise the solution. The stabilising additive may be di-ammonium hydrogen citrate, and the quantity added may be in the range of 0.01 to 0.05 wt % of the solution it is being added to. A stable solution may be a solution having a zeta potential with a magnitude of at least 40 mV.

According to a second aspect of the invention there is provided a wear-resistant object comprising a wear-resistant coating, the coating comprising a ceramic material and graphene nanoplatelets; wherein the coating has been applied to the object using the method of any embodiment of the first aspect.

In some embodiments, the porosity of the coating is less than 5%, or preferably less than 1%. In particular, such low porosities may indicate that the coating has been applied using HVOF spraying.

In some embodiments the coating may have a thickness in the range 20 μm to 200 μm, or in the range 50 μm to 70 μm.

In accordance with a third aspect of the invention there is provided a method of coating an object, the method comprising: preparing a suspension comprising graphene nanoplatelets; and spraying the suspension onto the object using high velocity oxy-fuel (HVOF) spraying in which the suspension is introduced as a feedstock (i.e. SHVOF spraying). The suspension may be a liquid suspension.

According to the third aspect, spraying the suspension using SHVOF spraying may comprise injecting the suspension into a flame having a flame power of between 20 kW and 40 kW. The flame power may be 25 kW. The injection flow rate of the suspension may be between 25 ml/min and 50 ml/min. The wt % of graphene nanoplatelets in the suspension may be between 5% and 10%.

According to the third aspect, the suspension may comprise substantially no ceramic material.

Aspects set out above in respect of the graphene nanoplatelet particle size also apply to the third aspect. The suspension may be an aqueous suspension. For example the graphene nanoplatelets may be dispersed in deionised water.

According to a fourth aspect of the invention there is provided a wear-resistant object comprising a wear-resistant coating, the coating comprising graphene nanoplatelets; wherein the coating has been applied to the object using the method of any embodiment of the third aspect.

### BRIEF DESCRIPTION OF THE DRAWINGS

The invention is described in further detail below by way of example and with reference to the accompanying drawings, in which:

FIG. 1 is a schematic representation of an HVOF apparatus for applying a coating to an object;

FIG. 2 shows SEM images (FIGS. 2(a)-(e)) and an EDX map (FIG. 2(f)) of a alumina+GNP coating;

FIG. 3 shows Raman spectroscopic maps (FIGS. 3(a)-(e)) and an optical image (FIG. 2(f)) of a cross-section of the sprayed alumina-GNP coating;

FIG. 4(a) shows mean Raman spectra of the unprocessed GNP, dispersed GNP prior to spraying, GNP within the sprayed coating, and spectra from the wear track of the 10 N Alumina/GNP sample extracted from the corresponding spectral maps;

FIG. 4(b) shows the distribution of ratio of D to G peak intensities (ID/IG) extracted from the mapped regions of pure GNP, dispersed GNP and the sprayed coating;

FIG. 5 shows XRD patterns of a pure alumina coating and the alumina+GNP coating;

FIG. 6 shows specific wear rates of alumina and alumina/GNP composite coatings at 10 N load for 4 hours (144 m);

FIG. 7 shows SEM images (FIGS. 7(a),(b)) and optical images (FIGS. 7(c),(d)) of counterbody wear tracks;

FIG. 8 shows profiles of wear tracks on the pure alumina and alumina+GNP coatings;

FIG. 9 shows coefficients of friction against time for alumina and alumina+GNP coating wear tests;

FIG. 10 shows specific wear rates for the pure alumina coating and the alumina+GNP coating;

FIG. 11 shows SEM images of wear tracks on the alumina+GNP coating at loads below the transition point to severe wear;

FIG. 12 shows coefficient of friction graphs for the pure alumina coating between 5 and 10 N load (FIG. 12(a), and the alumina+GNP coating between 10 and 35 N load (FIG. 12(b));

FIG. 13 shows SEM images of a GNP coating deposited on a stainless steel substrate;

FIG. 14 shows a Raman spectrum of a GNP coating deposited on a stainless steel substrate; and

FIG. 15 shows Raman spectroscopic maps of a GNP+TiO₂ coating.

### DETAILED DESCRIPTION

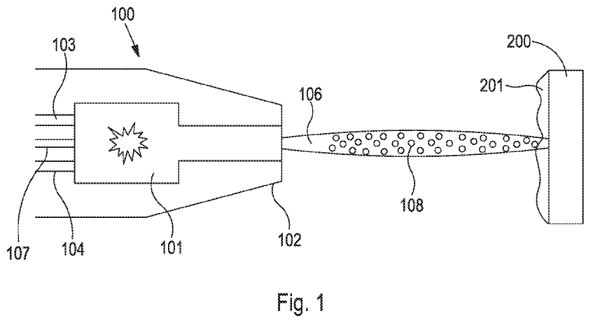

FIG. 1 shows an example HVOF apparatus 100 that may be used to spray a coating 201 according to an embodiment onto an object 200. Apparatus 100 comprises a combustion chamber 101 and a nozzle 102. Oxygen is fed into the combustion chamber 101 via an oxygen inlet 103. A combustion fuel, for example hydrogen, is fed into the combustion chamber 101 via a fuel inlet 104. The oxygen and the fuel combust in the combustion chamber 101, emitting a high temperature flame 106 through the nozzle 102 towards the object 200. A suspension feedstock is fed into flame 106 in the combustion chamber via feedstock inlet 107. The feedstock comprises a suspension comprising particles of a ceramic material and graphene nanoplatelets. The particles 108 of the feedstock are heated and accelerated towards the object 200 by the flame 106. The velocity of nanoparticles within the flame may be high enough to incorporate into the coating but low enough not to damage upon impact. The temperature of the nanoplatelets in the flame may be between 400-600° C., increasing the survivability of the nanoplatelets in the flame. The particles 108 are deposited on the surface of the object 200, forming a coating 201. The apparatus 100 may be scanned across the surface of the object 200 to form a coating 201 covering a larger area of the surface.

In an embodiment, an HVOF apparatus such as apparatus 100 was used to deposit a HVOF sprayed coating comprising ceramic material and graphene nanoplatelets in a suspension. In this example, alumina was used as the primary constituent of the sprayed composite, but other ceramic materials may also be used. For example, TiO₂ (anatase), TiO₂ (rutile), Cr₂O₃, ZrO₂ and TiN may be used, by producing a suspension of ceramic and graphene nanoplatelets using a similar method to that described below in relation to a graphene-alumina suspension. Alumina is known to be useful as a wear resistant coating, with good dry sliding wear properties, low cost, and good sprayability by HVOF. Alumina feedstock typically comprises the desirable alpha phase of alumina, which has the best wear performance of the various forms of alumina.

Given the high temperatures of the HVOF process, it is difficult to retain the alpha phase, and often the gamma phase forms, with poorer wear properties owing to its lower fracture toughness and hardness. Avoiding the gamma phase requires careful selection of typically lower flame energy parameters, which in turn can exacerbate the prevalence of porosity in the coating and hinder coating properties. Embodiments of the invention result in improved wear-resistance of an SHVOF alumina coating with a large percentage of gamma alumina, via the addition of GNPs to the feedstock. In order to demonstrate this, a feedstock was prepared by dispersing GNPs in a suspension of alpha alumina, prior to SHVOF spraying onto steel substrates, as described in more detail below. The wear performance was characterised in comparison to an equivalent alumina coating without GNPs, and the distribution and physical state of GNPs before and after spraying was measured by detailed Raman spectroscopic mapping.

### Preparation of the Suspension

A SHVOF sprayable suspension requires a good balance between surface charge (zeta potential), weight loading, pH, viscosity and shelf life. The final suspension must not separate during spraying or settle during storage and must have good flowability (for example 50-100 ml/min under 3 bars pressure) for spray deposition.

In the present study, a commercially pure (99.9%) alpha alumina feedstock was sourced from a specialised ceramic material supplier (Baikowski, France) with a D50 particle size of 1 μm (a D50 particle size in the range 1-10 μm may be used). The sub-micron powder was mixed with triple de-ionised water (other appropriate suspension media may be used) at 35 wt % (a % wt between 20 and 50 wt % may be used). The mixture was thoroughly mixed (in this example, with a digital mixer at a fixed rpm for three hours).

In order to confirm a stable suspension was achieved, the suspension was tested for sedimentation rate over a range of time periods in test tubes. In addition, the suspension was measured for electrokinetic potential (zeta potential) and modified to achieve a zeta potential between −40 mV and 40 mV. This was achieved by adding an acid or base solution to alter the pH, which affects the zeta potential. An additive (surfactant) was also added to the suspension to establish the desired zeta potential. A stabilising additive, such as di-ammonium hydrogen citrate may be used if the solution is not stable, for example between 0.01 and 0.05 wt % (relative to the solution) of additive may be added to the solution.

Once a stable alumina suspension was ready, a separate graphene nanoplatelet suspension was prepared.

Graphene nanoplatelets (GNP) having a 6-8 nm thickness (˜20 graphene layers) and 5 μm average diameter (ABCR product no. AB 304022) were used in this example, but. nanoplatelets having a thickness in the range 4 nm to 25 nm, and an average diameter in the range 1 μm to 7 μm may alternatively be used.

The GNP powder was dispersed in deionised water at a ratio of (1:105) and ultrasonicated at 20 kHz for 50 minutes. The dispersed GNP suspension was then introduced in the previously prepared alumina suspension and mixed in the digital mixer for a further 30 minutes. The ratio of GNP to alumina (by weight) is this recipe was maintained at 1:100 (but ratios up to 30:100 may be used).

The GNP+alumina suspension was then tested again for settlement and the zeta potential was measured to ensure a stable suspension was achieved in the above steps. If the solution is not stable, a stabilising additive may be added, as described above. The suspension was transferred to the suspension feeder vessel and agitated continuously under 3 bar pressure during the entire spray runs.

### Coating Preparation

SHVOF coatings of pure alumina and alumina+1% by weight GNP were sprayed onto steel substrates with dimensions of 60×25×2 mm. Substrates were grit blasted and cleaned with alcohol before coating. A modified UTP TopGun HVOF spray system, with a 0.3 mm suspension injector diameter was used for spraying. Hydrogen fuel was combusted in a 22 mm long chamber, into which the suspension was fed at a pressure of 3 bar (4-5 bar may be used) from a mechanically stirred, pressurised chamber. Injection flow rate was 100 ml/min for all tests (other flow rates, such as 80 to 120 ml/min may be used). Hydrogen was used as the fuel to combust with oxygen in the combustion chamber 101. Oxygen and hydrogen flow rates into the combustion chamber 101 were 306 and 611 l/min respectively, equating to a 100% combustion stoichiometry and 101 kW flame power (alternatively a stoichiometry in the range 90-100% may be used and/or a flame power in the range 80 kW to 120 kW). Substrates were mounted on a rotating carousel at 73 rpm (substrate speed of 1 m/s), while the spray gun was traversed perpendicular to the substrate movement direction, at a speed of 5 mm/s (speeds between 1 mm/s and 10 mm/s may be used), resulting in an interpass step of 4 mm, until a coating thickness of approximately 60 μm was achieved (alternatively a coating thickness between 20 and 80 μm may be applied). The stand-off distance was fixed as 85 mm for both coatings.

### Coating Characterisation

Cross-sectional coating analysis was performed after sequential SiC grinding and diamond polishing with a final grit size of 1 μm. All samples analysed by scanning electron microscopy (SEM) were platinum coated before inspection to provide sufficient electrical conductivity. Microscopy was performed using an FEI XL30 in secondary electron (SE) and back-scattered electron (BSE) modes and Hitachi S-2600 SEM in SE mode. X-ray diffraction (XRD) was performed with a Bruker D500 using Cu Kα radiation, wavelength 0.154 nm, and scanning from 5-120° 20 values, with a step size of 0.04° 2θ and a step time of 24 s. Raman spectroscopy was performed using a Horiba Jobin Yvon LabRAM HR spectrometer equipped with an automated xyz stage (Märzhäuser). Spectra were acquired using a 532 nm laser at 2.5 mW power, a 100× objective and a 300 μm confocal pinhole. To simultaneously scan a range of Raman shifts, a 600 lines/mm rotatable diffraction grating along a path length of 800 mm was employed. Spectra were detected using a Synapse CCD detector (1024 pixels) thermoelectrically cooled to ˜60° C. Before the spectra collection, the instrument was calibrated using the Rayleigh line at 0 cm⁻¹ and a standard Si(100) reference band at 520.7 cm⁻¹. During mapping, spectra were collected between 100 and 3000 cm⁻¹ across an area of 24×24 μm with a grid spacing of 1 μm along both the x and y axes, a total of 625 spectra per map. As each individual spectrum was collected for 20 seconds, repeated once in order to automatically remove the spikes due to cosmic rays, the whole map required approximately 7 hours of acquisition time. The height intensity of the D (1190-1470 cm⁻¹), G bands (1480-1700 cm⁻¹) and 2D bands (2600-2800 cm⁻¹), which are discussed in more detail below, and the corresponding intensity ratios, ID/IG and I2D/IG, were determined within the mapped cross-sectional area. Representative spectra were extracted from the mapped data set, corrected for fluorescence by application of a polynomial baseline subtraction and normalised to the intensity of the G band for comparison. The position and width of spectral features was determined using the Lorenzian peak fitting function in Labspec 6. Fracture surfaces were prepared by gradual bending of the substrate in a vice with the coating attached, yielded fracture surfaces in directions perpendicular, i.e. cross-sectional, and parallel to the top surface. Wear rates were measured by 5 contact profiles of each wear track, taken using a Talysurf CLI 1000 (Taylor Hobson) with a lateral resolution of 0.5 μm. Average cross-sectional area of the profiles was used to calculate total volume worn.

### Wear Testing

Ball-on-flat dry sliding wear testing was performed with a CETR UMT-2 micro-tribometer (CETR, USA), using a 6.3 mm diameter alpha-phase alumina ball counterbody (Dejay Ltd UK). Coatings were worn after sequential polishing using SiC followed by diamond to a final stage of 1 μm grit. An initial two tests were performed at 10 N load given the expected severe wear regime for the alumina sample at this parameter. Further wear tests were performed using a load range from 5-35 N and 10 mm stroke length, (5 mm track length) in order to find the transition points from mild to severe load for the both the pure alumina and the alumina+GNP coatings. Sliding speed was 10 mm/s in all tests.

### Results—Characterisation of Sprayed Coatings

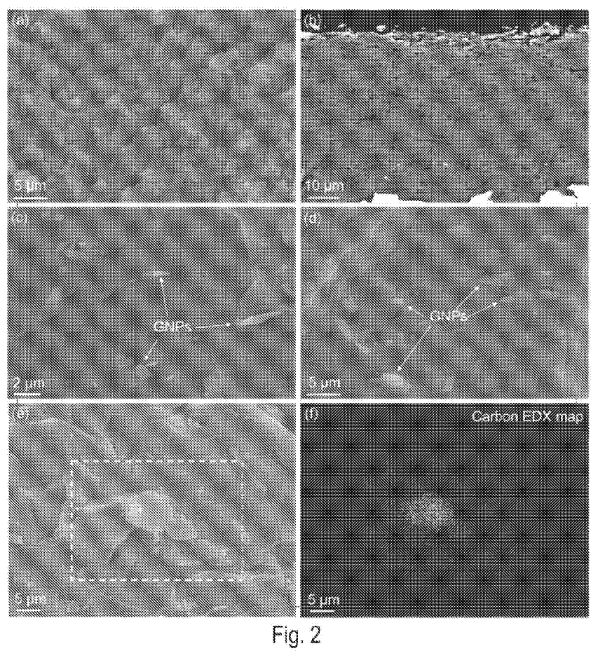

FIG. 2 shows SEM images of an alumina+GNP coating, showing (a) the coating surface, (b) the cross-section, and fracture surfaces (c) perpendicular to top surface and (d) parallel to the top surface. Numerous GNPs can be seen in various orientations. FIG. 2(e) is an SE image and FIG. 2(f) is an EDX map of a single GNP on a fracture surface showing the presence of elemental carbon in the location of a topological feature assumed to correspond to a GNP.

Based on SEM images (FIGS. 2(a)-(e)) of fracture surfaces, the GNPs appeared in tact in dimensions close to those of the original raw feedstock. EDX spectroscopy was used (FIG. 2(f)—showing an EDX map of the area within the rectangle in FIG. 2(e)) to identify carbon, and hence GNPs, given the absence of other carbon sources in the coating. Based on the fracture surface imaging, in both parallel and cross-sectional geometries, GNPs were well distributed, with little evidence of clustering. The orientation of platelets from fracture surface imaging however could not be determined in either orientation.

In order to (i) confirm and spatially locate the incorporation of GNPs into the coating subsequent to thermal spraying and (ii) determine the potential impact of thermal spraying on the structural properties of the GNP in the coating, Raman spectroscopic mapping was performed on a polished cross-section of the alumina+GNP coating.

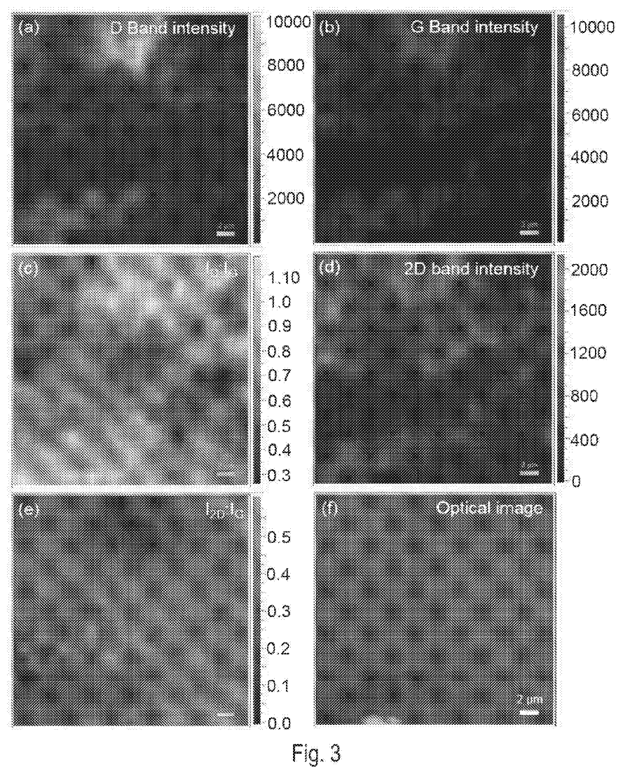

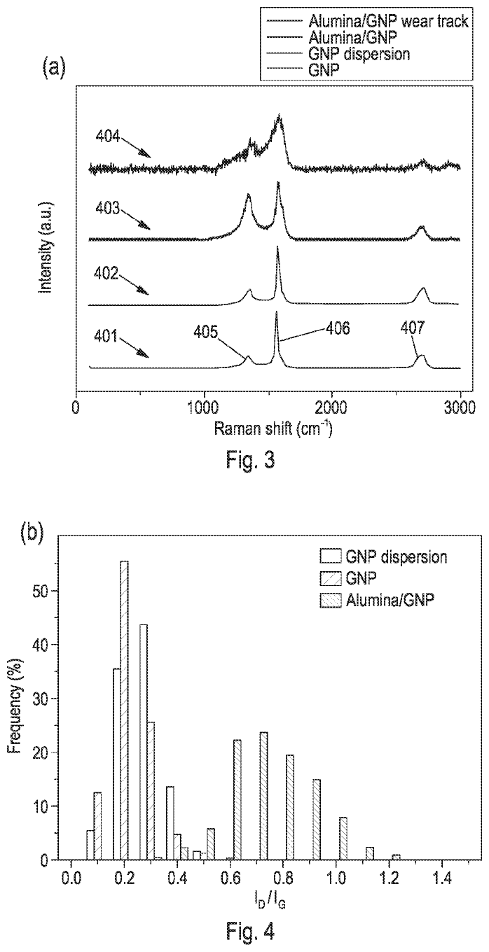

The Raman spectrum of GNPs is dominated by three spectroscopic features: the G band—a high frequency E2g optical phonon observed in all forms of nanoscale carbon at ˜1580 cm⁻¹ (peak 405 in FIG. 4(a); the D band—an A1g breathing mode of six-atom rings, requiring a defect for its activation, found in defective and nanocrystalline graphite at ˜1350 cm⁻¹ (peak 406 in FIG. 4(a); and the 2D band (sometimes referred to in the literature as the G′ band)—the second order of the D band at ˜2700 cm⁻¹ (peak 407 in FIG. 4(a)) [2]. Individual Raman spectra were collected at 1 μm intervals from an area 24×24 μm and the variation in the intensity of both D, G and 2D bands in the sprayed coating (FIGS. 3(a), (b) and (d)) correlated with spatial location.

The D, G and 2D band maps confirm that GNPs were present throughout the entire cross-section of the coating, with some evidence of clustering into 5-10 μm aggregates observed. The experimentally-determined penetration of the laser into the sample under the applied experimental conditions was of the order of ˜10 μm and thus differences in the observed intensity of bands in the lateral directions were likely to reflect the relative location of GNP in the axial direction (i.e. depth). However, in all recorded spectra, the presence of GNP was confirmed. FIG. 3(c) shows a spatial map of the ratio of D peak intensity to G peak intensity. Interestingly, this ID/IG map shows significant variation in the intensity ratio of D and G bands, indicative of the amount of disorder within a given graphitic plane, with spatial location ranging from 0.27-1.17. It is important to note that ID/IG was found to vary between 0.06-0.54 and 0.01-0.47 in analogous spectroscopic maps of the unprocessed GNP powder and a deposited GNP dispersion subsequent to ultrasonication respectively (mean values presented in Table 1), reflecting the dispersity of structural features common within nanoscale carbon materials and thus the necessity for careful, statistical treatment of associated spectroscopic analyses. Moreover, a shift in the mean value and broadening of the range of ID/IG subsequent to the formation of the coating indicates that the thermal spraying procedure, rather than the dispersion stage, results in subtle changes in the intensity of spectral features and thus the structural ordering within the GNP.

TABLE 1
Correlated I_{D}/I_{G} and I_{2D}/I_{G} values
for the GNP-containing materials.

| | I_{D}/I_{G} | | | I_{2D}/I_{G} | |
|---|---|---|---|---|---|
| | mean | range | L_{D}/nm | mean | range |
| GNP | 0.18 ± 0.08 | 0.06-0.54 | 28.5 | 0.23 ± 0.02 | 0.17-0.47 |
| powder | | | | | |
| GNP | 0.22 ± 0.08 | 0.01-0.47 | 25.7 | 0.21 ± 0.04 | 0.09-0.34 |
| dispersion | | | | | |
| alumina- | 0.70 ± 0.16 | 0.27-1.17 | 14.4 | 0.32 ± 0.09 | 0.01-0.60 |
| GNP | | | | | |
| coating | | | | | |

Comparison of the mean Raman spectra of GNP (FIG. 4(a)) extracted from the maps of the sprayed coating and the unprocessed GNP respectively clearly demonstrate the differences in structural ordering in the GNP. In FIG. 4(a), line 401 shows the spectrum of the unprocessed GNPs, line 402 the spectrum of the GNPs dispersed in suspension, line 403 the spectrum of the SHVOF applied alumina/GNP coating (before wear testing), and line 404 the spectrum from the wear track of the alumina/GNP coating after 10 N wear testing. Spectra have been baseline corrected for fluorescence, normalised to the intensity of the G band for ease of comparison and shifted on the y-axis for clarity. FIG. 4(b) shows the distribution of ID/IG extracted from the mapped regions of pure GNP, dispersed GNP and the sprayed coating.

In addition to an increase in the mean ID:IG ratio from 0.18±0.08 to 0.70±0.16 (FIG. 4(b)), a ˜2-fold enhancement in the width of the D (from 54 to 92 cm−1) and G bands (from 22 to 40 cm−1) further supports the formation of a more structurally defective GNP subsequent to thermal spraying. An apparent shift in the position of the G band subsequent to spraying is associated with the activation of the D′ band at ˜1620 cm−1, a further indicator of the formation of structural defects. Interestingly, there is no change in the intensity (relative to the G band), position or width of the 2D band, as displayed in the I2D:IG map (FIG. 3(e)), indicating that spraying does not lead to stacking faults or changes to the number of graphitic layers within a given stack. Thus, the changes in structure are limited to intralayer (rather than interlayer) disordering.

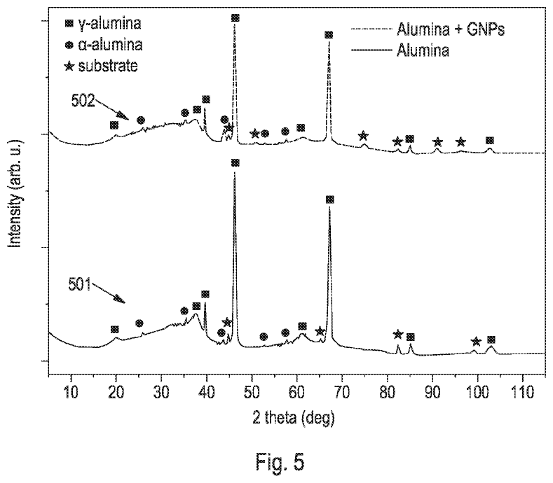

The results of X-ray diffraction (XRD) are shown in FIG. 5. XRD was performed on the pure alumina (line 501) and alumina+GNP (line 502) coatings in order to confirm that addition of GNPs does not affect the alumina based microstructure of the coating. An almost identical microstructure was observed for both coating types, consisting of a majority of gamma alumina with some small alpha peaks, indicating that most of the alpha-phase alumina converted to gamma-phase during the HVOF spraying. Both coatings contained a considerable amorphous content, with crystallinity calculated via Rietveld refinement to be ˜26%, with 95% of crystalline material composed of gamma alumina, and 3% attributed to alpha, and a minor amount to underlying steel substrate material detected. GNP loading in the coating was too small to be measurable by XRD.

### Results—Wear Tests at 10 N

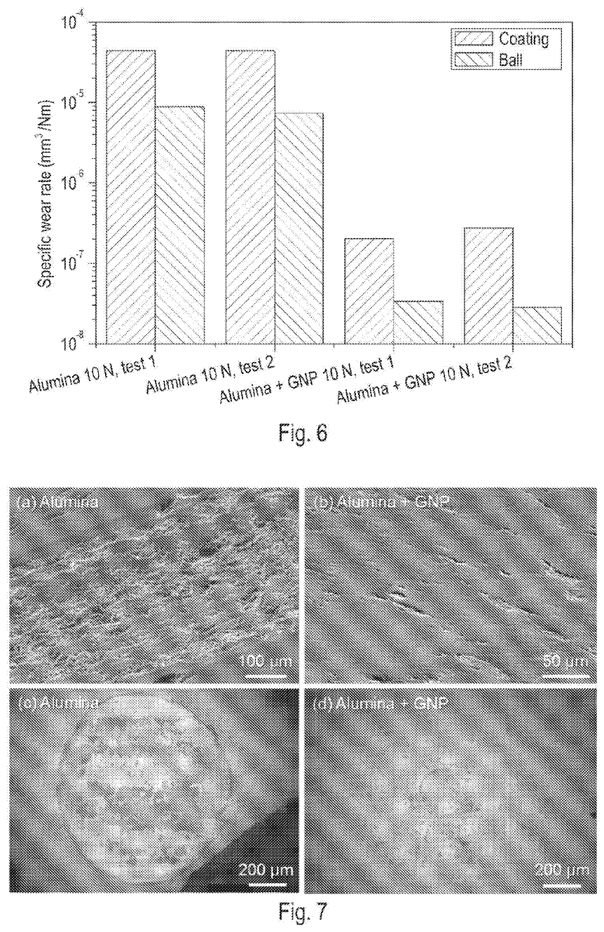

For initial wear tests, a load of 10 N and sliding speed of 10 mm/s, and 4 hours wear time were chosen, as previous work had shown that this parameter caused an unmodified alumina coating to enter into a severe wear regime. Hence, these parameters were chosen in order to determine if GNP reinforcement fundamentally altered the wear mechanism. Two repeats were performed for each test. Specific wear rates of the wear tracks on coating and counterbodies, based on volume measurement, are shown in FIG. 6.

After 4 hours of wear, the alumina/GNP composite coatings yielded a specific wear rate more than two orders of magnitude lower than the pure alumina coatings, from ˜3×10⁻⁵ to ˜1-2×10⁻⁷ mm³/Nm. In all cases, the specific wear rate of the counterbody, composed of alpha alumina, was lower than that of the corresponding coating, reflecting the superior performance of the alpha alumina counterbody. Ball wear rates were also reduced by more than two orders of magnitude for the alumina/GNP wear tests. SEM images of coating wear tracks are shown in FIG. 7.

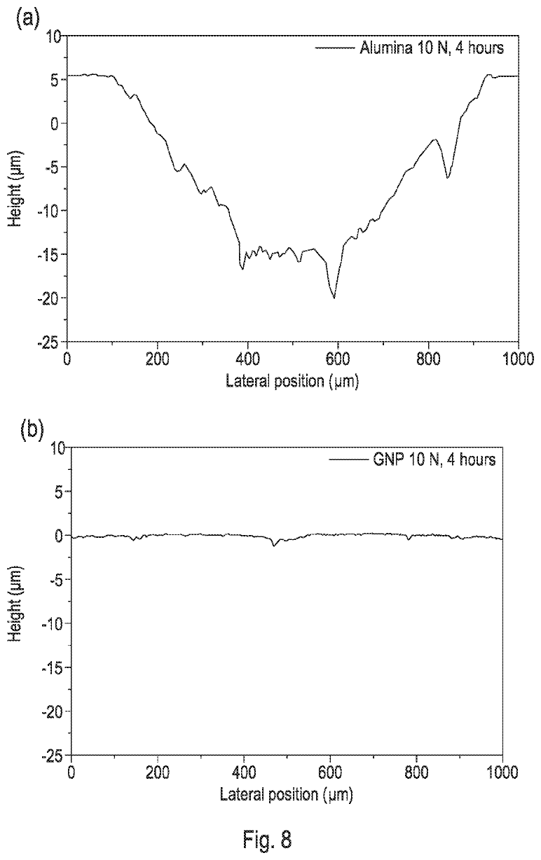

A wear track characteristic of a severe wear regime can be seen on the pure alumina coating (FIG. 7(a)), characteristic of a brittle fracture mechanism. In contrast, the wear track on the Alumina+GNP coating (FIG. 7(b)) reveals a mild wear mechanism characteristic of a small level of plastic deformation. In FIGS. 7(c) and (d), wear tracks on the alumina counterbodies worn against the alumina and alumina+GNP coatings respectively are shown. A large wear track with evidence of adhesion of coating material to the track can be seen in (c), whereas a much smaller track was yielded on the ball worn against the GNP coating. In FIG. 8, linear profiles are shown taken across the wear tracks, from which specific wear rate volumes were taken (FIG. 8(a) shows a profile across the wear track of the pure alumina coating, and FIG. 8(b) shows a profile across the wear track of the alumina+GNP coating). The alumina coating yielded a ˜20 μm deep wear track with a rough topography and clean, sharp track edges. The alumina+GNP coating however produced a wear track with a depth on the order of <1 μm. Track width was also smaller by a factor of ˜5.

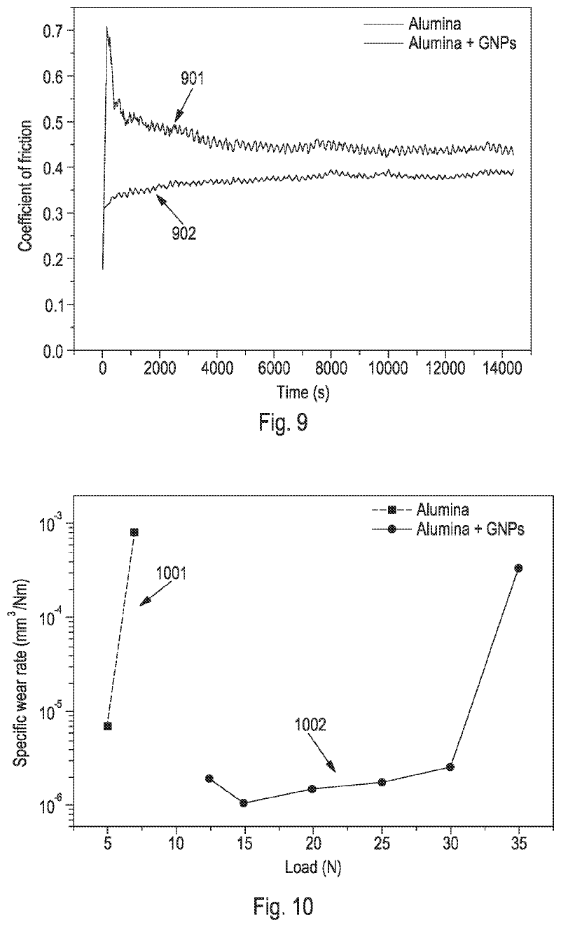

Coefficients of friction for one of each of the two test types can be seen in FIG. 9. Line 901 shows the coefficient of friction for the pure alumina coating, and line 902 the coefficient of friction for the alumina+GNP coating. Several key differences can be seen between the friction profiles for the two wear tests. Firstly an initially rapid increase in friction force to 0.7 was produced in the pure alumina coating, which then sharply decreased. This can be contrasted with the initial increase to 0.3 for the alumina+GNP coating, which did not reduce again after this point. Secondly after the initial running in period, the alumina coating maintained a slightly higher coefficient of friction compared to the alumina+GNP coating: ˜0.45 compared to ˜0.35. It should also be noted that the friction behaviour is more erratic for the pure alumina coating, likely reflecting the removal of material and hence change of surface during the test.

Results—Wear with Increasing Loads

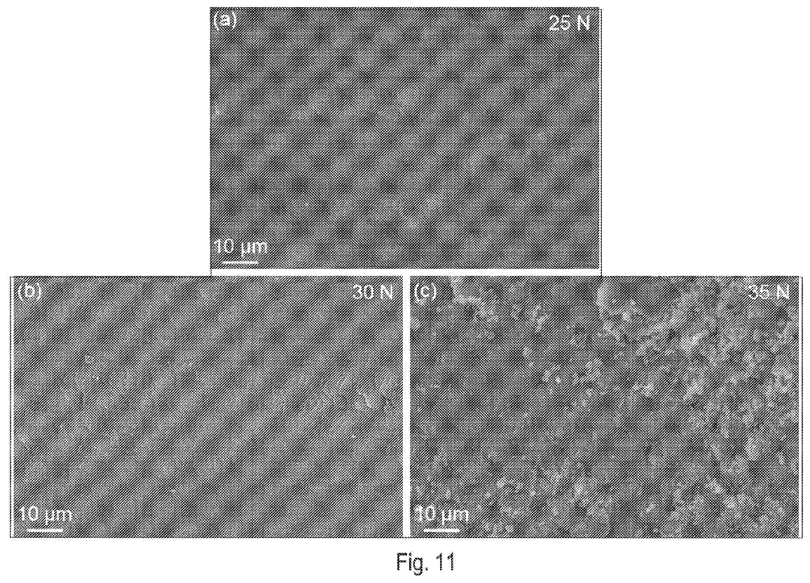

Initial testing at 10 N and 4 hour wear time revealed a two order of magnitude improvement in specific wear rate with the addition of 1 wt % GNPs to the alumina coating, via the transition to an apparent mild wear mechanism. However to fully characterise the wear behaviour of the two coatings, and specifically to determine the difference in wear mechanism transition points, wear tests were repeated using a range of loads. FIG. 10 shows specific wear rates for the pure alumina coating (line 1001) at 5 and 7.5 N, and for the alumina+GNP coating (line 1002) at 12.5, 15, 20, 25, 30 and 35 N. All tests were performed for 30 mins, except for the 35 N test which was stopped after 2.5 mins, due to potentially equipment-damaging high friction levels.

After reducing wear test load on the pure alumina coating to 7.5 N, the wear rate remained high, with a deep wear track and track topography typical of a severe wear regime. Upon reducing to 5 N load, a shallow wear track, with a specific wear rate two orders of magnitude lower than at 7.5 N, indicative of a mild regime was produced, implying the transition for the pure alumina coating between mild and severe wear exists between loads of 5 and 7.5 N. The alumina+GNP coating was then tested with increasing loads. For between 12.5 and 30 N, no significant difference in wear track volume was seen, resulting in specific wear rates relatively consistent between these parameters. At 35 N, wear testing resulted in very high friction, and the test was stopped after 2.5 minutes to avoid machine damage. Specific wear rate at 35 N was measured at approximately two orders of magnitude higher than tests between 12.5 and 30 N. The transition point from mild to severe wear for the Alumina+GNP coating was hence measured to be between 30 and 35 N, hence 4-5 times higher than for the alumina coating.

To explain the shift in transition point, SEM images were taken of the wear track surfaces of 25, 30 and 35 N tests on the alumina+GNP composite coating, as shown in FIGS. 11(a), 11(b) and 11(c) respectively.

At 30 N, a relatively smooth wear track was produced, with grooves characteristic of plastic flow, but with no evidence of intergranular fracture or wear debris. The 25 N wear track showed a similar morphology to the 30 N sample, albeit with smaller grooves indicative of plastic flow, and again no evidence of intergranular fracture. At 35 N load, the wear track is typical of a severe wear regime, with extensive wear debris, and a rough, pocketed surface characteristic of grain pull out following intergranular fracture. Flat regions characteristic of plastic flow are also present.

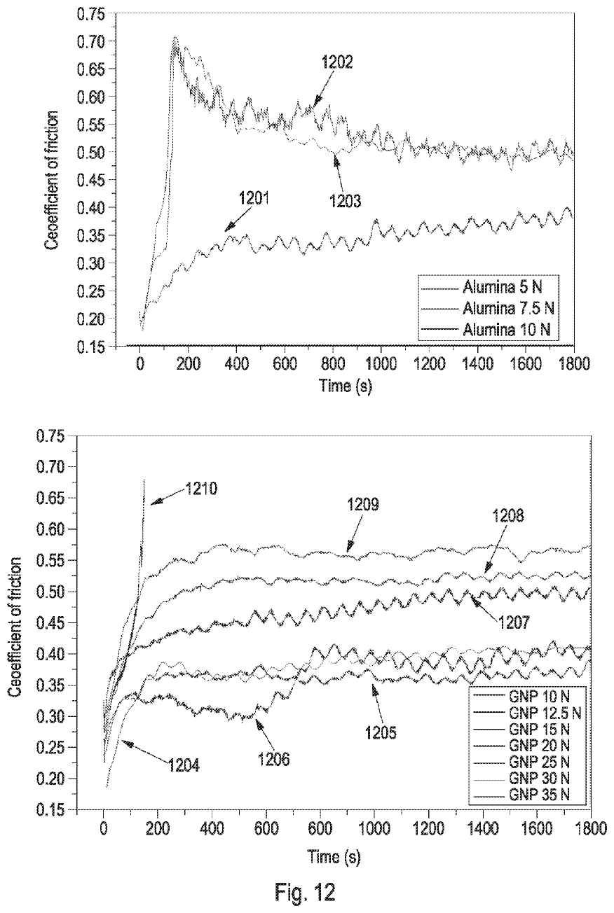

FIG. 12 shows coefficients of friction as a function of time for increasing loads for the two coating types. FIG. 12(a) shows the coefficient of friction for the pure alumina coating at 5 N (line 1201), 7.5 N (line 1202), and 10 N (line 1203). FIG. 12(a) shows the coefficient of friction for the alumina+GNP coating at 10 N (line 1204), 12.5 N (line 1205), 15 N (line 1206), 20 N (line 1207), 25 N (line 1208), 30 N (line 1209), and 35 N (line 1210).

For the pure alumina coating, at 7.5 and 10 N, a rapid initial increase in friction was observed, followed by a gradual decrease towards a steady state coefficient of friction of ˜0.5. In contrast, the 5 N sample experienced only a gradual initial increase to ˜0.3, followed by a steady but gradually increasing coefficient of friction. For the GNP coating, all tests except at 35 N showed an initial friction increase at a shallower rate than the pure alumina coating at 7.5 and 10 N. The 35 N coating displayed an immediately sharp rise in friction to ˜0.7, at which point the test was stopped. Generally, the mean friction level during wear reflects both the load and the regime of the wear process (i.e. highest for severe wear, lower for mild wear with high load, and lower again for mild wear and low loads).

### Results—Coating a Stainless Steel Substrate Using a GNP Suspension

Direct suspension spraying of graphene nano-platelets (GNPs) onto a stainless steel substrate has also been carried out using high velocity oxy-fuel, HVOF, spraying. In this manner a GNP coating has been deposited on a stainless steel substrate.

The suspension did not include a ceramic such as alumina or TiO₂. A GNP suspension was prepared in a manner as described above in the “preparation of the suspension” section, except that it was not subsequently mixed with a separate suspension of alumina. A HVOF flame power of 25 kW was used.

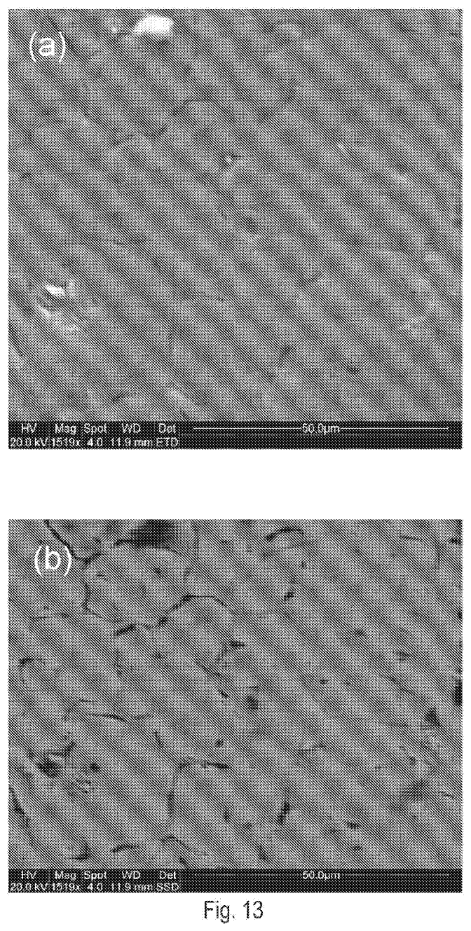

Scanning electron microscope (SEM) top surface images of deposition at 25 kW flame power are shown in FIG. 13. FIG. 13(a) is an SEM top surface image of GNPs deposited on a stainless steel substrate, where the SEM was operated in secondary electron (SE) mode. FIG. 13(b) is an SEM top surface image of GNPs deposited on a stainless steel substrate, where the SEM was operated in back-scattered electron (BSE) mode.

It is found that the GNPs withstand the interaction with the hot jet/flame without melting. They are found to stay attached to the stainless steel substrate throughout the deposition and analysis processes. The coating evenly covers areas of 50 μm² in the SEM images. There are some defects in the coating (seen as the darker areas in FIG. 13(b), but the coverage is generally very good.

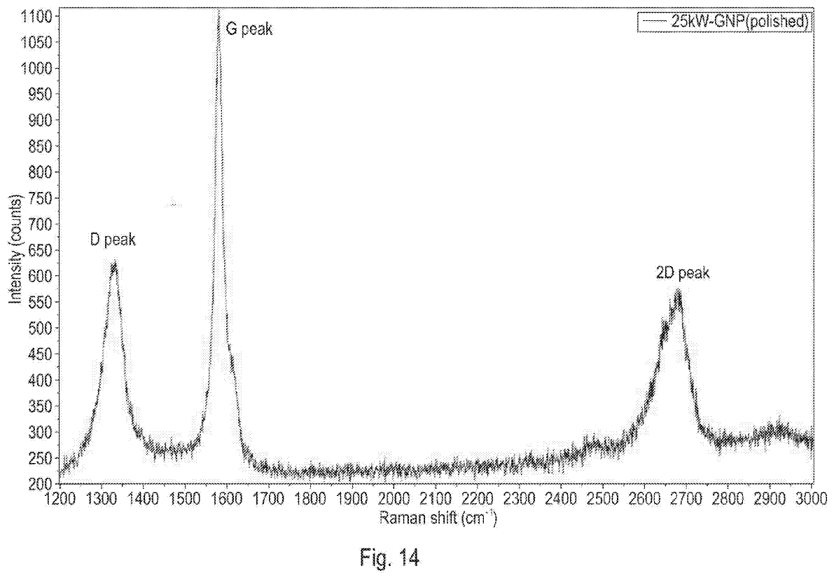

Additional information about the coating deposited on the stainless steel substrate is provided from further analyses carried out using Raman spectroscopy. With this technique it is possible to discriminate between various states of carbon and to investigate whether graphitisation has occurred during deposition. A Raman spectrum of the deposited coating is shown in FIG. 14 and indicates the presence of multi-layered graphene in the deposited coating. Specifically, the G and 2D bands show that carbon is present in the coating. The G/2D ratio suggests the presence of multi-layered graphene. The D band suggests a certain degree of disorder in the graphene lattices (mostly due to platelets boundaries).

Results—Suspension Spraying of TiO₂ and TiO₂+GNP Nanocomposites

Suspension spaying of GNPs+TiO₂ (titania) has been carried out to form nanocomposite coatings using HVOF spraying. The process steps involved in the deposition are similar to those described herein for the alumina and GNP suspension. The mechanical and wear characteristics for the TiO₂+GNP coating have been analysed and compared to TiO₂-only coatings, and are presented in Table 2 below.

As is evident from the results presented in Table 2, when compared to titania-only coatings, titania+GNP coatings exhibit: higher microhardness, higher fracture toughness and lower specific wear rate

TABLE 2
mechanical and wear characteristics of titania +
GNP coatings compared to titania-only coatings

| | | | Coating | Counterbody |
|---|---|---|---|---|
| | Micro- | Fracture | Specific | Specific |
| | hardness | Toughness | Wear Rate | Wear Rate |
| Coating | (HV_{0.025}) | (MPa × m^{1/2}) | (mm³/Nm × 10⁻³) | (mm³/Nm) |
| Titania | 270 ± 70 | 0.58 ± 0.83 | 3.60 ± 0.99 | Negligible |
| Titania + | 352 ± 48 | 1.04 ± 0.57 | 0.78 ± 0.30 | Negligible |
| GNP | | | | |

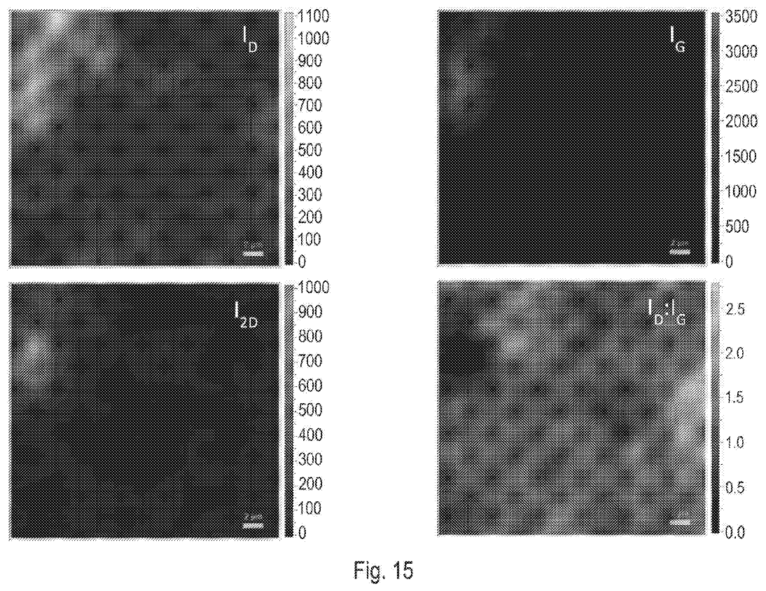

The presence of GNPs in the titania+GNP coating has been assessed using Raman spectroscopy. The results are presented in FIG. 15 which shows Raman maps of various characteristic peaks of carbon, indicating the presence of GNPs. From these results we conclude that GNPs are present in the coating and that they retain their multi-layered structure.

### Discussion of Results—Raman Spectroscopy

Raman spectroscopic mapping revealed that the sprayed coating contained a homogeneous distributed mixture of GNP forms within the analysed cross-section. Statistical treatment of data extracted from the spectral maps indicated that the mean ID:IG ratio increased from 0.18±0.08 in the unprocessed GNP to 0.70±0.16 in the coating, corresponding to a 50% reduction in distance between defects, LD, from 28.5 to 14.4 nm according to LD=1.8×10−9.λ4.(ID/IG)−1 [3]. For perspective, a fully disordered graphene layer may have an ID:IG ratio of over 3 [2]. The ratio of D and G band intensities is often used to quantify defectiveness in graphene related systems, such as GNP, and is known to vary with the amount of disorder (deviation from an ideal sp2-hybridised carbon lattice due to the incorporation of point defects, such as resonant scatterers and substitutional atoms) within a given graphitic plane. Whilst distributions in the ID:IG ratio are typical in nanoscale carbon materials, the shift in the mean and broadening of the range of ID:IG subsequent to processing indicates that the thermal spraying procedure results in moderate changes in the structural ordering within the GNP, as has been observed previously in analogous studies on the incorporation of CNTs in alumina by HVOF [4]. Raman analysis of the GNP after dispersion but before spraying (line 402 in FIG. 4(a)), rules out the effect of ultrasonication on the defectiveness of the GNPs after spraying. Given the feedstock is passed through a combustion chamber in the presence of a combusted fuel at elevated temperatures, increases in the number and changes in the nature of structural defects in nanocarbons are likely, including the incorporation of substitutional atoms through chemical functionalisation, and may account for the increase in ID:IG of the GNPs after spraying. Given that there is no change in the intensity (relative to the G band), position or width of the 2D band, this suggests that spraying does not lead to changes in the number or orientation of graphitic layers within a given GNP and thus, whilst moderate intralayer disorder has been introduced, the afforded GNP within the coating retains much of the structural integrity and thus functional properties of the unprocessed parent material.

### Discussion of Results—Wear Behaviour

Wear testing showed a two order of magnitude reduction in specific wear rate due to the addition of GNPs at 10 N load, explained by a significant shift in the transition point between mild and severe wear regimes, from between 5 and 7.5 N for pure alumina, and between 30 and 35 N for the alumina+GNP composite. Given the 35 N test was stopped after only 1.5 metres wear distance, significant wear debris is visible, which has been freshly removed from the coating structure by the wear process, and has not yet undergone further deformation. It is therefore clear that brittle fracture of the coating, which leads to grain pull-out, is prevented until a much higher load point in the case of the alumina+GNP coating. The friction data, for example in FIG. 9, shows there is not a significant reduction in friction coefficient for the alumina+GNP coating after the initial run-in period, despite the entirely different wear regimes taking place. In FIG. 12, it is shown that mean friction coefficient for the alumina+GNP coating gradually increases with increasing load, up to ˜0.55 during the 30 N test, despite the mild regime still taking place. Hence, in terms of measured friction during wear tests, the addition of GNPs to the alumina coating does not yield a notable reduction in friction. We can consider the Raman spectra taken from the wear track on the 10 N alumina+GNP sample to determine the presence and condition of GNPs on the worn surface. Spectra are shown in FIG. 4. This data revealed a much lower intensity of bands associated with GNP present on the worn surface in comparison to an equivalent sized cross-sectional region of the coating. The spectra observed indicate that GNPs are present, however the absolute intensity of the signal is notable reduced in comparison with that of the coating cross-section. The presence of small peaks in the location of the D and G peaks, resulting in overall widening of the peaks, suggests that amorphous carbon is also present on the worn surface. This means that quantification of the intensity ratios of the D and G bands cannot be accurately determined. It is possible that the amorphous carbon detected on the surface is a product of the wear process, for example dissipation of frictional heat combined with stress under loading resulting in damage to GNPs present near the surface. In some embodiments, there may be sufficient GNPs near the surface to generate a tribofilm, thereby reducing friction [5]. In the example embodiment, the low absolute intensity of peaks associated with GNPs on the worn surface of the coating is evidence against the formation of a GNP based tribofilm. Furthermore, the distribution of GNPs was sparse in both cross-sectional and parallel geometries within the example coating, with individual platelets typically separated by distances of ˜1-5 μm. Considering that the mild regime wear tracks, i.e. tests up to 30 N for the alumina+GNP coating, have a maximum 3 μm depth, it is thought that individual GNPs in the example coating are too sparse to be redistributed as an effective, uniform tribofilm during the wear process, and the Raman data collected on the 10 N track supports this. However it is possible that isolated regions of the coating with a concentration of GNPs prior to wear, result in small areas of film formation after the initial run in period during wear testing. Other work has explained the improved wear behaviour of similar composites through the increase of fracture toughness, for example in the case of silicon nitride/GNP composites in which increased fracture toughness was measured and explained improved wear behaviour at low temperatures, although the contribution of presence of GNPs on the surface cannot be ruled out [6]. It has been shown that fracture toughness of bulk alumina composites can be increased by the addition of 0.5% by weight GNPs, from a mean of ˜3.5 to ˜5.5 MPa·m½ [7]. A similar significant increase has been shown in silicon nitride/GNP composites at 1% loading, followed by a drop in fracture toughness at higher wt % [8]. Given that fracture toughness is a well-known contributor to dry sliding wear resistance in ceramics [9], and explained the improved wear behaviour of alpha sprayed alumina vs gamma alumina in the authors' previous work [10], increased fracture toughness likely explains the increased dry sliding wear resistance of the alumina+GNP composite coating in this work.

Thus it has been shown that, surprisingly, a composite coating of a ceramic and graphene nanoplatelets can be sprayed by suspension HVOF spraying, without the nanoplatelets disintegrating in the high temperature of the HVOF flame.

Coatings according to embodiments have good coverage, and provide much greater wear-resistance than a pure alumina coating applied by HVOF spraying.

Other embodiments are intentionally within the scope of the invention as defined by the appended claims.

### REFERENCES

[1] KESHRI, A. K., et al., Structural transformations in carbon nanotubes during thermal spray processing. Surface & Coatings Technology 203:2193-2201 (2009).
[2] DRESSELHAUS, M. S. et al., Perspectives on Carbon Nanotubes and Graphene Raman Spectroscopy. Nano Letters 10(3):751-8 (2010).
[3] CANÇADO, L. G. et al., Quantifying Defects in Graphene via Raman Spectroscopy at Different Excitation Energies. Nano Letters 11(8):3190-6 (2011).
[4] JAMBAGI, S. C. et al., Plasma sprayed carbon nanotube reinforced splats and coatings. Journal of the European Ceramic Society 37(5):2235-44 (2017)
[5] YAZDANI B. et al., Tribological performance of Graphene/Carbon nanotube hybrid reinforced Al2O3 composites. Scientific Reports 5:11579 (2015).
[6] BALKO J. et al., Wear damage of Si3 N4-graphene nanocomposites at room and elevated temperatures. Journal of the European Ceramic Society 34(14):3309-17 (2014).
[7] YAZDANI B. et al., Graphene and carbon nanotube (GNT)-reinforced alumina nanocomposites. Journal of the European Ceramic Society 35(1):179-86 (2015).
[8] BÓDIS E. et al., Spark plasma sintering of Si3 N4/multilayer graphene composites. Open Chemistry 13(1):484-489 (2014).
[9] OLOFSSON J., Friction and wear mechanisms of ceramic surfaces: with applications to micro motors and hip joint replacements. 2011
[10] MURRAY J. W. et al., High Velocity Oxy-Fuel (SHVOF)-Sprayed Alumina Coatings: Microstructure, Nanoindentation and Wear. Journal of Thermal Spray Technology 2016:1-11.

What is claimed is:

1. A method of coating an object, the method comprising:
preparing a suspension comprising graphene nanoplatelets and a ceramic material; and
spraying the suspension onto the object using high velocity oxy-fuel, HVOF, spraying in which the suspension is introduced as a feedstock.

2. The method of claim 1, wherein the suspension comprises graphene nanoplatelets having a thickness in the range 4 nm to 25 nm.

3. The method of claim 1, wherein the suspension comprises graphene nanoplatelets having an average thickness in the range 5 nm to 10 nm, or in the range 6 nm to 8 nm.

4. The method of claim 1, wherein the suspension comprises graphene nanoplatelets having an average diameter in the range 1 μm to 7 μm, or in the range 4 μm to 6 μm.

5. The method of claim 1, wherein the ceramic material is or comprises alumina; and/or gamma-phase alumina.

6. (canceled)

7. The method of claim 5, wherein after SHVOF spraying the ceramic material comprises at least 50 wt % or at least 70 wt % or at least 90 wt % gamma-phase alumina.

8. The method of claim 1, wherein the wt % of graphene nanoplatelets in the suspension is in the range 1% to 30% of the wt % of the ceramic material in the suspension.

9. The method of claim 1, wherein spraying the suspension using SHVOF spraying comprises injecting the suspension into a flame, and wherein the ratio of flame power to injection flow rate of the suspension is between 0.5 and 1.5 kW(ml/min)⁻¹, or between 0.8 and 1.2 kW(ml/min)⁻¹ and/or ii) the flame has a flame power between 80 kW and 120 kW.

10. (canceled)

11. The method of any preceding claim, wherein preparing the suspension comprises:
preparing a first suspension comprising the ceramic material;
preparing a second suspension comprising the graphene nanoplatelets; and
combining the first and second suspensions.

12. The method of claim 11, wherein combining the first and second suspensions comprises adding the second suspension to the first suspension.

13. The method of claim 1, wherein the suspension is an aqueous suspension.

14. The method of claim 1, wherein the ceramic material comprises particles having a particle size in the range 1 μm to 20 μm, or in the range 1 μm to 10 μm.

15. A wear-resistant object comprising a wear-resistant coating, the coating comprising a ceramic material and graphene nanoplatelets;
wherein the coating has been applied to the object using the method of claim 1.

16. The object of claim 15, wherein the porosity of the coating is less than 5%, or preferably less than 1%.

17. The object of claim 15, wherein the coating has a thickness in the range 20 μm to 200 μm, or in the range 50 μm to 70 μm.

18. A method of coating an object, the method comprising:
preparing a suspension comprising graphene nanoplatelets; and
spraying the suspension onto the object using high velocity oxy-fuel, HVOF, spraying in which the suspension is introduced as a feedstock.

19. The method of claim 18, wherein spraying the suspension using HVOF spraying comprises injecting the suspension into a flame having a flame power of between 20 kW and 40 kW, and preferably 25 kW.

20. The method of claim 18, wherein the injection flow rate is between 25 ml/min and 50 ml/min.

21. The method of claim 18, wherein the suspension has a wt % of graphene nanoplatelets of between 5% and 10%.

22. The method of claim 18, wherein the suspension comprises substantially no ceramic material.

23. (canceled)
